(19) United States
(12) Patent Application Publication
(10) Pub. No.: US 2011/0236042 A1
(43) Pub. Date: Sep. 29, 2011

(54) IMAGE FORMING APPARATUS

(75) Inventor: Yasuki TANAKA, Kanagawa (JP)

(73) Assignee: FUJI XEROX CO., LTD., Tokyo (JP)

(21) Appl. No.: 12/870,871

(22) Filed: Aug. 30, 2010

(30) Foreign Application Priority Data
Mar. 24, 2010 (JP) 2010-068262

(51) Int. Cl. G03G 15/00; G03G 21/00

(52) U.S. Cl. 399/21; 399/124

(57) ABSTRACT

An image forming apparatus includes: an image forming unit that forms an image on recording paper; a paper feeding unit that feeds the recording paper to the image forming unit; an opening/closing door that is provided to be opened/closed by an operator; a paper conveyance path through which the recording paper is conveyed from the paper feeding unit through the image forming unit to a paper outlet, the paper conveyance path including a maintenance feasible conveyance path and a maintenance infeasible conveyance path that does not allows the operator to maintain even if the opening/closing door is opened; and a residual paper detecting unit that detects residual paper remaining on the maintenance infeasible conveyance path. New recording paper is fed to the paper conveyance path when the residual paper detecting unit has detected the residual paper after opening and closing the opening/closing door.

### CROSS-REFERENCE TO RELATED APPLICATIONS

This application is based on and claims priority under 35 USC 119 from Japanese Patent Application No. 2010-068262 filed on Mar. 24, 2010.

### BACKGROUND

1. Technical Field

The present invention relates to an image forming apparatus.

2. Related Art

There is proposed an image forming apparatus such as a copying machine or a printer that employs the electrophotographic method or the like. The image forming apparatus includes, on a housing of the apparatus, a maintenance cover that may be opened/closed for an operation to be performed in a paper jam or the like, that is, so-called jam processing, so as to open the maintenance cover for performing the jam processing.

### SUMMARY

According to an aspect of the invention, an image forming apparatus includes and image forming unit, a paper feeding unit, an opening/closing door, a paper conveyance path and a residual paper detecting unit. The image forming unit forms an image on recording paper. The paper feeding unit feeds the recording paper to the image forming unit. The opening/closing door for maintenance is provided to be opened/closed by an operator. The recording paper is conveyed through the paper conveyance path from the paper feeding unit through the image forming unit to a paper outlet. The paper conveyance path includes a maintenance feasible conveyance path that allows an operator to maintain with the opening/closing door opened and a maintenance infeasible conveyance path that does not allows the operator to maintain even if the opening/closing door is opened. And, the residual paper detecting unit detects residual paper remaining on the maintenance infeasible conveyance path. New recording paper is fed to the paper conveyance path when the residual paper detecting unit has detected the residual paper after opening and closing the opening/closing door.

### BRIEF DESCRIPTION OF THE DRAWINGS

Exemplary embodiment(s) of the present invention will be described in detail based on the following figures, wherein:

FIG. 1 is a schematic outline diagram illustrating the structure of an image forming apparatus according to an exemplary embodiment of the invention;

FIGS. 2A and 2B are schematic diagrams explaining the structure of a fixing unit of the exemplary embodiment, and specifically, FIG. 2A is a schematic perspective view thereof and FIG. 2B is a schematic diagram illustrating arrangement of the fixing unit within the image forming apparatus;

FIG. 3 is a flowchart explaining contents of a residual paper removing mode of the exemplary embodiment;

FIG. 4 is a timing chart illustrating operations of respective composing elements performed in the residual paper removing mode of the exemplary embodiment; and

FIG. 5 is a diagram illustrating a result of verification of a rate of removing residual paper in employing the residual paper removing mode of the exemplary embodiment.

### DETAILED DESCRIPTION

An exemplary embodiment of the invention will be described with reference to the accompanying drawings.

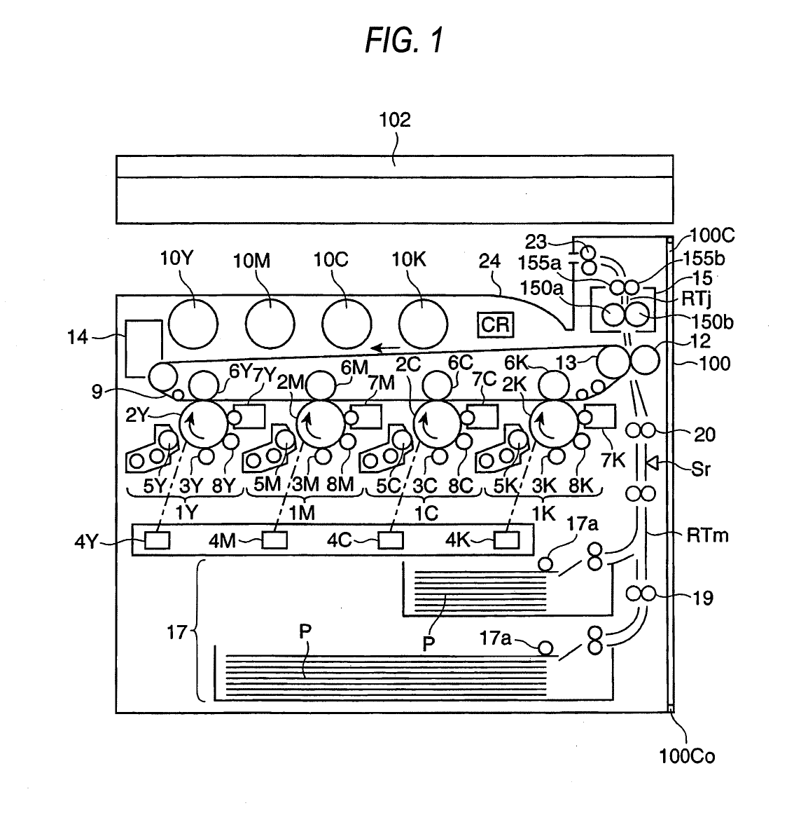

First, an image forming apparatus according to an exemplary embodiment of the invention will be described with reference to FIG. 1. FIG. 1 is a schematic diagram roughly illustrating the structure of a tandem color image forming apparatus 100 to which the invention is applicable.

Incidentally, in this image forming apparatus 100, on the basis of not only color image information of a color manuscript read by an image reading device 102 but also color image information transmitted from a personal computer, an image data input device or the like not shown, image processing of the image information is performed.

In FIG. 1, reference numerals 1Y, 1M, 1C and 1K denote image formation units working as an image forming unit as a whole for forming toner images respectively of yellow (Y), magenta (M), cyan (C) and black (K), and these image formation units 1Y, 1M, 1C and 1K are arranged in this order in a row along a proceeding direction of an endless intermediate transfer belt 9 suspended by a plurality of suspending rollers. Also, the intermediate transfer belt 9 is an intermediate transfer substance onto which the toner images of the respective colors successively formed by the image formation units 1Y, 1M, 1C and 1K are transferred to overlap one another, and is formed to be inserted between photosensitive drums 2Y, 2M, 2C and 2K, that is, electrostatic latent image holding substances respectively corresponding to the image formation units 1Y, 1M, 1C and 1K, and primary transfer rollers 6Y, 6M, 6C and 6K respectively provided opposingly to the photosensitive drums, so as to be circulative at a prescribed speed in a direction of an arrow. The toner images of the respective colors having been multiply-transferred onto the intermediate transfer belt 9 are transferred as a whole onto recording paper P corresponding to a recording medium fed from a paper cassette 17 and the like, and are fixed by a fixing unit 15, so that the recording paper P having a color image formed thereon may be discharged to the outside.

In this case, the image reading device 102 has a structure for irradiating a manuscript placed on a platen glass with a light source not shown and reading reflected light from the manuscript with an image reading element such as a CCD sensor through a scanning optical system with precedently determined resolution (of, for example, 16 dots/mm).

Furthermore, the image formation units 1Y, 1M, 1C and 1K have the same structure, roughly speaking, including the photosensitive drum 2Y, 2M, 2C or 2K rotatively driven at a precedently determined speed along a direction of an arrow and working as an image holding substance; a charging roller 3Y, 3M, 3C or 3K for uniformly charging the surface of the photosensitive drum 2Y, 2M, 2C or 2K; an exposing device 4Y, 4M, 4C or 4K including the scanning optical system and forming, on the photosensitive drum 2Y, 2M, 2C or 2K, an electrostatic latent image by exposing an image of each corresponding color; a developing device 5Y, 5M, 5C or 5K for developing the electrostatic latent image formed on the photosensitive drum 2Y, 2M, 2C or 2K into a toner image of each color; and a drum cleaning device 7Y, 7M, 7C or 7K for cleaning the surface of the photosensitive drum 2Y, 2M, 2C or 2K, and the like.

Furthermore, in this exemplary embodiment, toner cartridges 10Y, 10M, 10C and 10K for supplying prescribed developers (that is, principally toners or toners including carriers) of the corresponding colors respectively to the developing devices 5Y, 5M, 5C and 5K corresponding to the respective colors of yellow (Y), magenta (M), cyan (C) and black (K) are provided above the intermediate transfer belt 9 to be removable from a main body of the image forming apparatus 100. It is noted that “CR” indicates an apparatus controller including a CPU, a ROM, a RAM and the like for controlling operations of respective composing elements of the image forming apparatus 100.

Each of the photosensitive drums 2Y, 2M, 2C and 2K of this exemplary embodiment includes a metal drum rotating in the direction of the arrow and having, on its surface, a photosensitive layer made of an organic photosensitive material, an amorphous selenium-based photosensitive material, an amorphous silicon-based photosensitive material or the like, and the charging rollers 3Y, 3M, 3C and 3K are formed to be in contact with the surfaces of the photosensitive drums 2Y, 2M, 2C and 2K, respectively so as to charge the photosensitive layers formed thereon to precedently determined potential.

Image forming processing performed in the image forming apparatus having the aforementioned structure will now be explained by describing the image formation unit 1Y for forming a yellow toner image as a representative example.

First, the surface of the photosensitive drum 2Y is uniformly charged by the charging roller 3Y. Next, on the basis of, for example, image information read by the image reading device 102, scanning exposure corresponding to a yellow image is performed with laser beams emitted from the exposing device 4Y, so as to form an electrostatic latent image corresponding to the yellow image on the surface of the photosensitive drum 2Y.

This electrostatic latent image corresponding to the yellow image is developed into a yellow toner image by the developing device 5Y, and the yellow toner image is primarily transferred onto the intermediate transfer belt 9 through pressing force and electrostatic attraction caused by the primary transfer roller 6Y included in a primary transferring unit. A portion of the yellow toner remaining on the photosensitive drum 2Y after the primary transfer is scraped off by the drum cleaning device 7Y. Thereafter, the surface of the photosensitive drum 2Y is eliminated for charge by a static eliminator 8Y before being charged again by the charging roller 3Y for a next image forming cycle.

In the present image forming apparatus 100 for multi-color image formation, similar image forming processing is performed also in the image formation units 1M, 1C and 1K at timing determined in consideration of relative positional differences among the image formation units 1Y, 1M, 1C and 1K, so as to form a full-color toner image on the intermediate transfer belt 9 as a result of overlapping toner images of the respective colors. As the intermediate transfer belt 9, a flexible synthetic resin film of polyimide or the like is formed into a belt shape, both ends of the belt-shaped synthetic resin film are connected to each other by adhesion or the like, and the thus obtained endless belt-shaped film may be used.

The full-color toner image primarily transferred onto the intermediate transfer belt 9 is secondarily transferred onto recording paper P, which is conveyed to a secondary transfer position at precedently determined timing, through pressing force and electrostatic attraction caused by a backup roller 13 supporting the intermediate transfer belt 9 and a secondary transfer roller 12 pressed against the backup roller 13 at precedently determined timing. It is noted that toners remaining on the intermediate transfer belt 9 not secondarily transferred onto the recording paper P are conveyed to a belt cleaning device 14 while remaining on the intermediate transfer belt 9 and is removed from the intermediate transfer belt 9 by the belt cleaning device 14 as preparation for next image formation.

On the other hand, the recording paper P in a precedently determined size is fed from the paper cassette 17 corresponding to a paper feeding unit disposed in a lower portion of the image forming apparatus 100 by a paper feeding roller 17a. The fed recording paper P is conveyed to the secondary transfer position of the intermediate transfer belt 9 at precedently determined timing along a paper conveyance path RT including a plurality of conveyor rollers 19 and resist rollers (timing adjusting rollers) 20. Then, as described above, the full-color toner image is transferred as a whole from the intermediate transfer belt 9 by the backup roller 13 and the secondary transfer roller 12 corresponding to a secondary transferring unit. It is noted that a resist sensor (a paper detecting unit) Sr for detecting the presence of recording paper P on the paper conveyance path RT is provided in the vicinity of the resist rollers 20 in this exemplary embodiment.

Furthermore, the recording paper P on which the full-color toner image has been secondarily transferred from the intermediate transfer belt 9 is separated from the intermediate transfer belt 9 and is conveyed to the fixing unit 15 disposed on the downstream side of the secondary transferring unit, so that the toner image is fixed on the recording paper P through heat and pressure applied by the fixing unit 15. After the fixing, the recording paper P is discharged through discharging rollers 23 onto a paper output tray 24.

In this exemplary embodiment, a maintenance cover (opening/closing door) 100C formed rotatably around a rotation support 100C₀ is provided on a side face of the main body of the image forming apparatus 100 for what is called jam processing performed at time of a paper jam or the like. Specifically, an operation button not shown is provided in an upper portion of the maintenance cover 100C, and the maintenance cover 100C may be opened/closed by pressing (pushing down) the operation button. It is noted that the opening/closing state of the maintenance cover 100C may be detected by a sensor not shown.

Due to demands for further compactness of the apparatus and further cost reduction, on the premise that replacement, maintenance and the like of the composing elements (such as the image formation units 1 and the fixing unit 15) are performed by a technical engineer, the image forming apparatus 100 of this exemplary embodiment employs a simple structure in which an opening/closing cover and the like for each composing element having an accessory mechanism are omitted as much as possible and, with respect to the maintenance cover 100C also working as a reinforcement member for protecting the internal elements and the like, its opening range (i.e., a range where a user may perform maintenance with the maintenance cover 100C opened) is restricted (reduced) to the utmost.

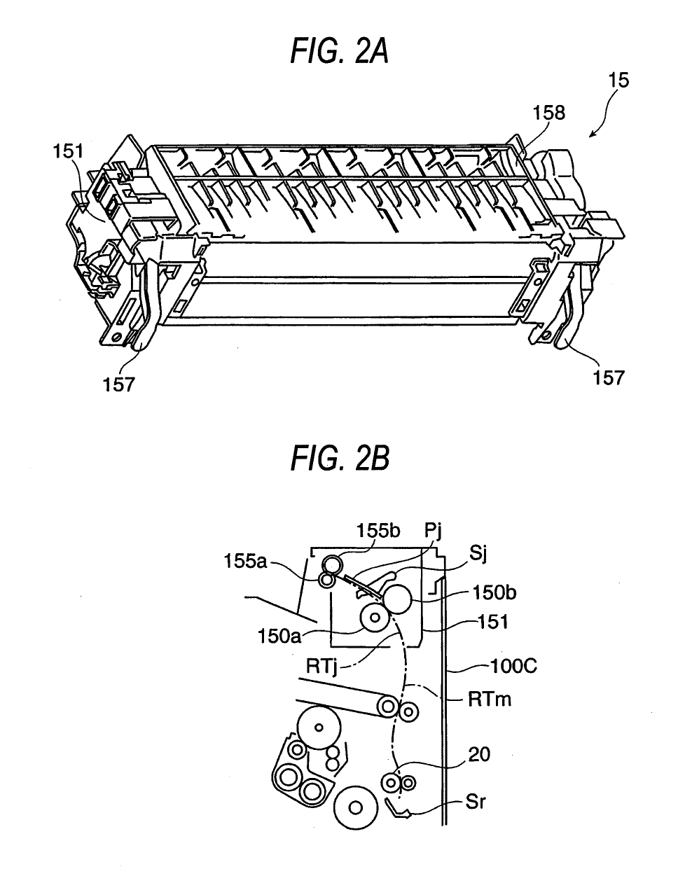

For example, in the fixing unit 15 of this exemplary embodiment, as illustrated in FIGS. 2A and 2B, a heating roller 150a and a pressing roller 150b working as a pair of fixing rollers opposing each other and forming a fixing pressing portion (a fixing nip portion) N therebetween, a pair of unit discharging rollers (a discharging unit) 155a and 155b disposed on the downstream side of the fixing rollers 150a and 150b, and the like are fixedly provided inside a unit housing 151 with a closed structure, and a portion of the paper conveyance path RT disposed inside the fixing unit 15 is out of sight from an operator when the maintenance cover 100C is opened. In other words, in the structure of this exemplary embodiment, maintenance and the like of the composing elements disposed inside the unit housing 151 cannot be performed by an operator (a user). Incidentally, pressure releasing levers 157 with which an operator (a user) may release pressing force applied to the fixing nip portion N are provided outside the unit housing 151 in both end portions along a roller shaft direction.

The heating roller 150a has a heat source such as a halogen lamp inside and is connected to a driving section not shown provided in one end portion along the shaft direction to be rotatable. On the other hand, the pressing roller 150b opposes the heating roller 150a and is pressed against the heating roller 150a with a precedently determined pressure, so as to follow the rotation of the heating roller 150a. Furthermore, a temperature sensor not shown for measuring the surface temperature of the heating roller 150a is provided in the vicinity of the heating roller 150a of this exemplary embodiment, so as to control the surface temperature of the heating roller 150a at a precedently determined temperature on the basis of measurement by the temperature sensor.

Moreover, the pair of unit discharging rollers 155a and 155b are disposed at an opening on the downstream side of the unit housing 151, so that the recording paper P having been subjected to the fixing processing through heating and pressing in the nip portion N of the fixing rollers 150a and 150b may be grasped therebetween and conveyed to be discharged to the paper output tray 24 outside the unit housing 151. It is noted that a reference numeral 158 denotes a conveying guide fixedly provided on the upper section of unit housing 151.

Similarly, in a portion between the fixing rollers 150a and 150b and the unit discharging rollers 155a and 155b disposed inside the unit housing 151, a residual paper detecting sensor (a residual paper detecting unit) Sj for detecting recording paper P present in this portion of the paper conveyance path RT is provided.

Specifically, in the image forming apparatus 100 of this exemplary embodiment, in the paper conveyance path RT through which recording paper P is conveyed, a portion of the paper conveyance path disposed on the upstream side of the fixing unit 15 (i.e., a portion of the paper conveyance path disposed below the fixing unit 15 in FIG. 1) is visible from an operator (a user) when the maintenance cover 100C is opened, and hence is formed as a maintenance feasible conveyance path RTm where the jam processing may be performed by the operator (namely, is accessible by the operator), and on the other hand, a portion of the paper conveyance path disposed inside the fixing unit 15 is provided within the unit housing 151 with the closed structure, and hence is out of sight from the operator (the user) even when the maintenance cover 100C is opened, and therefore, is formed as a maintenance infeasible conveyance path RTj where the jam processing cannot be performed by the operator (namely, is inaccessible by the operator). The residual paper detecting sensor Sj and the resist sensor Sr are appropriately set and provided so that recording paper P remaining on the maintenance infeasible conveyance path RTj may be detected by the aforementioned residual paper detecting sensor Sj and that recording paper P remaining on the maintenance feasible conveyance path RTm may be detected by the resist sensor Sr.

In the structure including the paper conveyance path RTj impossible to be maintained by an operator (a user) on the basis of the demands for compactness and cost reduction as described above, when a paper jam occurs, the user opens the maintenance cover 100C and removes recording paper P remaining on the paper conveyance path RTm which is in the visible range. In this case, for example, if recording paper P remains to be caught between the fixing roller pair 150a and 150b, there are frequent cases where the user pulls the recording paper P from the side of the visible paper conveyance path RTm to remove the paper without operating the pressure releasing levers 157, and it has been found through study of the present inventor that the recording paper P tends to be torn to partly remain in the maintenance infeasible paper conveyance path RTj (in the portion of the paper conveyance path disposed inside the fixing unit 15 in this exemplary embodiment) in these cases. In particular, it has been found that torn residual paper Pj not grasped by the adjacent conveyor roller pair but present between the conveyor roller pairs (as illustrated in FIG. 2B) is very difficult to remove by merely idling the conveyor rollers.

Therefore, in the image forming apparatus 100 of this exemplary embodiment, a residual paper removing mode as described below is provided so as that residual paper Pj remaining on the maintenance infeasible conveyance path RTj (in particular, residual paper Pj present between adjacent conveyor roller pairs) may be removed. Incidentally, the residual paper removing mode of this exemplary embodiment may be easily realized by applying the existing paper detecting sensors Sr and Sj and a control function of the existing apparatus controller CR without additionally providing any specific member.

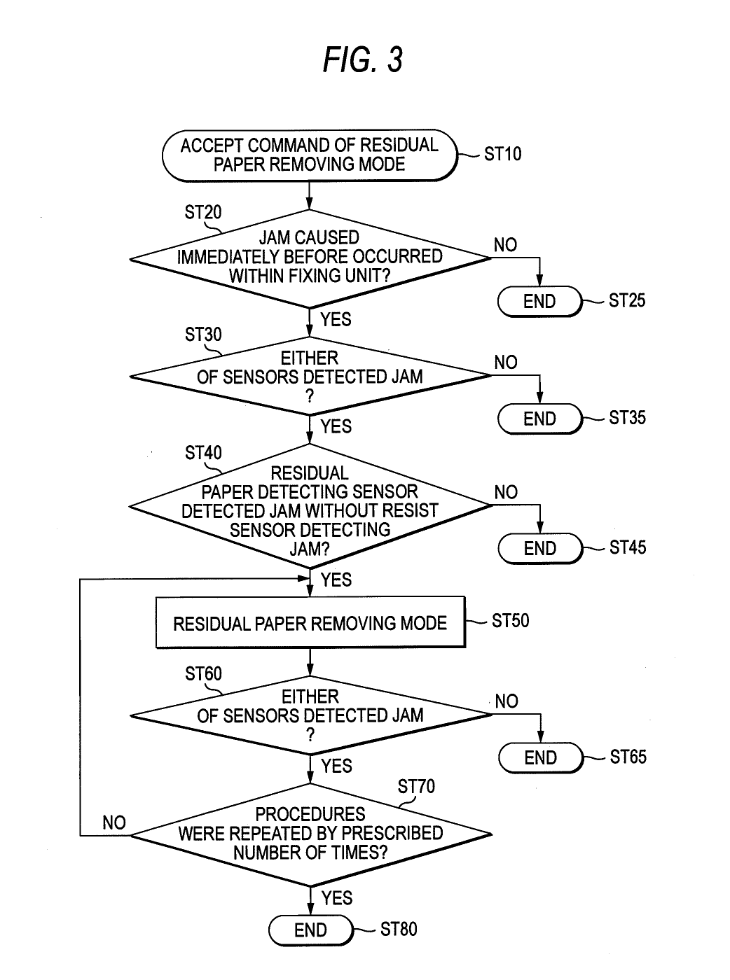

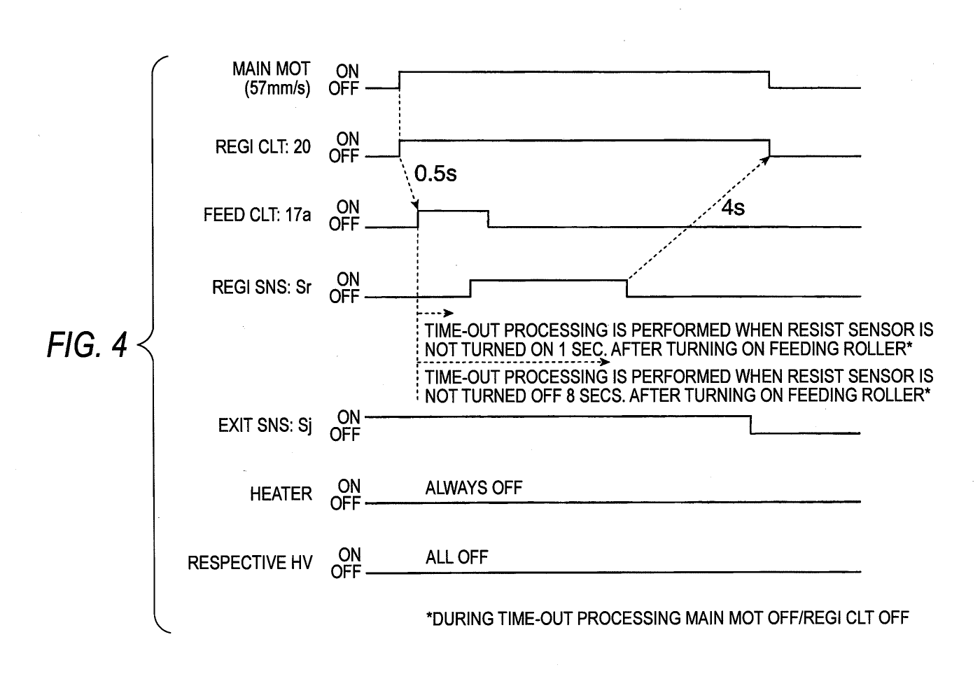

Now, the contents of the residual paper removing mode of this exemplary embodiment will be described with reference to FIGS. 3 and 4. FIG. 3 is a flowchart explaining the contents of the residual paper removing mode of this exemplary embodiment, and FIG. 4 is a timing chart of operations of the respective composing elements performed in the residual paper removing mode.

As illustrated in the flowchart of FIG. 3, after an opening/closing operation of the maintenance cover 100C (i.e., after the jam processing), the image forming apparatus is first placed in a command waiting state of the residual paper removing mode (step ST10).

Next, it is determined whether or not the jam having occurred immediately before (i.e., having occurred before the operation of the maintenance cover 100C) was caused in the maintenance infeasible conveyance path RTj. Specifically, in this exemplary embodiment, it is determined whether or not a paper jam occurred within the fixing unit 15 (i.e., whether or not the residual paper detecting sensor Sj detected residual paper Pj) (step ST20). When the jam having occurred immediately before was not caused within the fixing unit 15 (namely, when the residual paper detecting sensor Sj did not detect residual paper Pj in the jam immediately before), the apparatus is shifted to a standby state of a normal operation (a normal control mode), and the processing is terminated (step ST25).

When YES in step ST20, it is next determined whether or not the residual paper detecting sensor Sj or the resist sensor Sr has detected recording paper P (step ST30). When none of the sensors Sj and Sr has detected recording paper P, it is determined that recording paper P has been removed through the jam processing, and the apparatus is shifted to the standby state of the normal operation (the normal control mode), and the processing is terminated (step ST35).

When YES in step ST30, it is further determined whether or not the residual paper detecting sensor Sj has detected residual paper Pj and the resist sensor Sr has detected no recording paper P (step ST40).

When NO in step S40 (i.e., when at least the resist sensor Sr has detected recording paper P), it is determined that recording paper P is present at least on the maintenance feasible conveyance path RTm in the vicinity of the resist roller 20, and an operator is urged to perform the jam processing again by, for example, displaying occurrence of a jam on an operation panel, and the processing is terminated (step ST45).

On the other hand, when YES in step ST40, it is determined that no recording paper P is present on the maintenance feasible conveyance path RTm and that residual paper Pj is present on the maintenance infeasible conveyance path RTj, and the apparatus is shifted to the residual paper removing mode, so as to feed new recording paper P₀ from the paper cassette 17 to the paper conveyance path RT (step ST50). Thus, the residual paper Pj is pushed by the new recording paper P₀ out of the image forming apparatus or to the conveyor roller pair disposed on the downstream side, so that the residual paper Pj may be removed.

Thereafter, it is determined again whether or not the residual paper detecting sensor Sj or the resist sensor Sr has detected recording paper P (step ST60), and when none of the sensors Sj and Sr has detected the recording paper P, it is determined that the residual paper Pj has been removed through the residual paper removing mode, and the apparatus is shifted to the standby state of the normal operation (the normal control mode), and the processing is terminated (step S65).

On the other hand, when either of the sensors Sj and Sr has detected recording paper P in step ST60, it is determined that the residual paper Pj still remains, and new recording paper P₀ is fed again (step ST60), and if it is determined that the residual paper Pj is not removed even after repeating the procedures of steps ST50 through ST60 by a prescribed number of times (for example, five times), the residual paper removing mode is terminated, and an apparatus error or the like is displayed on the operation panel, and the processing is terminated (step ST80). In this manner, unlimited feed of new recording paper P₀ may be prevented employing the residual paper removing mode.

Next, as specific operations of the respective composing elements performed in shifting to the residual paper removing mode, as schematically illustrated in FIG. 4, the resist roller 20 is driven at the same time of driving a main motor, and after prescribed time (of, for example, 0.5 sec.) has elapsed, the feeding roller 17a is driven. Thereafter, the resist sensor Sr is turned on for paper detection, and in the case where the resist sensor Sr is not turned on even when prescribed time (of, for example, 1 sec.) has elapsed after turning on the feeding roller 17a, it is determined that an error is caused in the resist sensor Sr, and time-out processing (for turning off the main motor and the resist roller) is performed, and the residual paper removing mode is terminated.

Similarly, also in the case where the resist sensor Sr is not turned off even when prescribed time (of, for example, 8 secs.) has elapsed after turning on the feeding roller 17a, it is determined that an error is caused in the resist sensor Sr, and the time-out processing (for turning off the main motor and the resist roller) is performed, and the residual paper removing mode is terminated. It is noted that the heat source and a high voltage power source may be all placed in an off-state in the residual paper removing mode because there is no need to form an image in this mode.

However, from the viewpoint of preventing stain with a toner adhered to residual paper Pj, the heating roller 150a of the fixing unit 15 may be heated in the residual paper removing mode. In this case, even when residual paper Pj prior to the fixing is present in the fixing nip portion N, by performing the fixing processing through heating and pressing the residual paper Pj, a part inside the apparatus or an operator may be prevented from being stained with a toner not fixed. Incidentally, in the case where heating is performed in the fixing unit 15, necessary and minimum fixing energy is sufficient for preventing toner adhesion caused by residual paper Pj, and hence, the heating is performed preferably at a lower temperature (of, for example, 100° C.) than a general fixing temperature (of, for example, approximately 170° C.) from the viewpoint of energy saving.

Similarly, from the viewpoint of more effectively removing torn residual paper Pj remaining on the maintenance infeasible conveyance path RTj by electrostatically adhering it onto new recording paper P₀, the new recording paper P₀ may be charged by the secondary transfer roller 12 provided on the paper conveyance path RT in feeding the new recording paper P₀.

Furthermore, before feeding new recording paper P₀ (i.e., before shifting to the residual paper removing mode), the conveyor rollers including the fixing rollers 150a and 150b and the unit discharging rollers 155a and 155b may be idled. Here, “idling” means an operation of the rollers performed without conveying recording paper. In this case, a possibility of discharging residual paper Pj caught by either of the conveyor roller pairs may be increased without wastefully providing new recording paper P₀. Incidentally, after the idling, the residual paper detecting sensor Sj may be operated so as to detect the residual paper Pj again.

Next, results of verification of performance for removing residual paper Pj by employing the residual paper removing mode of this exemplary embodiment will be described.

Specific verification was performed as follows: A jam in which recording paper P was caught and stopped in the fixing nip portion N was caused, the recording paper P was pulled (drawn out) by five times from the side of the maintenance feasible conveyance path RTm in each direction of an upward direction, a horizontal direction and a downward direction respectively toward a side of AD (that is, an end along the shaft direction on a side not provided with the driving section), straightway and toward a side of D (that is, an end along the shaft direction on a side provided with the driving section) without releasing the nip pressure (i.e., without operating the nip pressure releasing levers 157), and a rate of occurrence of residual paper Pj and a rate of removal of residual paper Pj by employing the residual paper removing mode were verified. It is noted that a conveying speed (a process speed) was set to 57 mm/s (10 ppm).

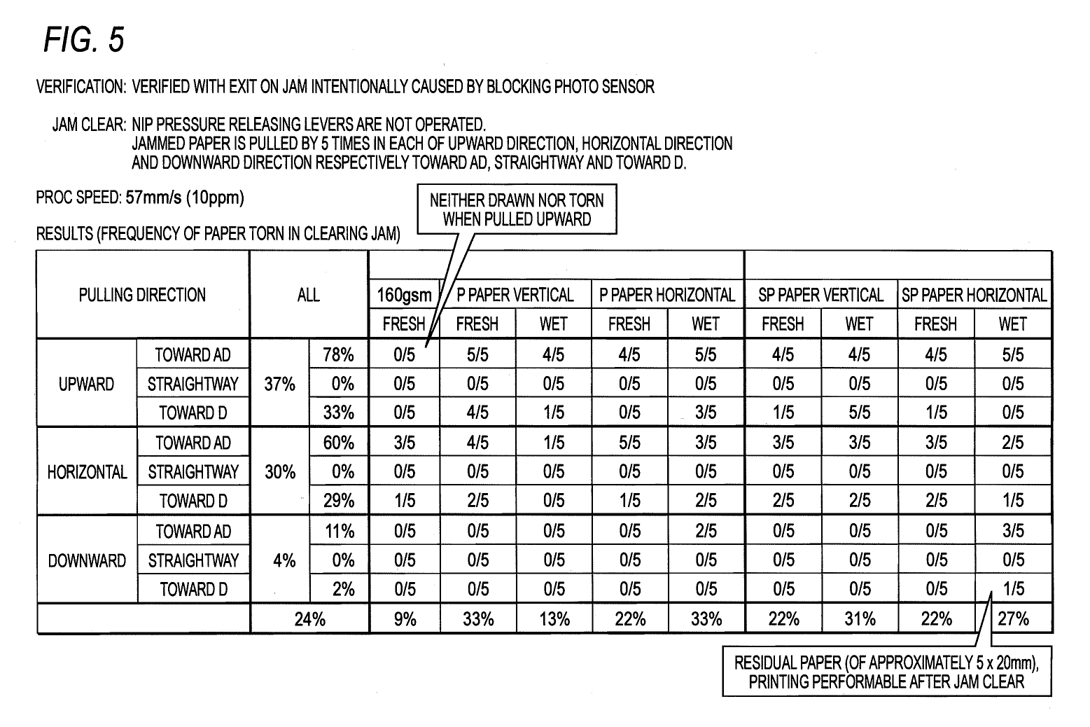

As a result of the verification performed under the aforementioned conditions, as illustrated in FIG. 5, the ratio of occurrence of residual paper Pj remaining inside the fixing unit 15 caused by pulling recording paper P in a jammed state (i.e., a state where the recording paper P is caught in the fixing nip portion N) 405 times in total was 24% (specifically, as a result of pulling the recording paper P in the jammed state 405 times, the residual paper Pj was caused 96 times). Incidentally, the residual paper Pj remaining inside the fixing unit 15 was caused only when the recording paper was pulled toward either end in the shaft direction (toward the side of AD or D). At this point, in FIG. 5, “160 gsm” indicates thick paper, “P paper” indicates ordinary paper (for example, with a thickness of approximately 64 gsm), and “SP paper” indicates thin paper (for example, with a thickness of approximately 56 gsm).

Thereafter, when new recording paper P₀ was fed by employing the residual paper removing mode of this exemplary embodiment, the rate of removing the residual paper Pj remaining within the fixing unit 15 was 99% (specifically, the residual paper Pj caused 96 times was removed 95 times).

In this manner, it was confirmed that residual paper Pj present in the maintenance infeasible conveyance path RTj housed in the closed housing (in particular, in the portion of the paper conveyance path disposed between the conveyor rollers such as between the fixing roller pair 150a and 150b and the unit discharging roller pair 155a and 155b) may be easily discharged with a simple structure without additionally providing any specific member by employing the residual paper removing mode of this exemplary embodiment.

It is noted that the technical scope of the invention is not limited to the exemplary embodiment described above but various modifications or variations may be made without departing from the spirit of the invention as defined in the appended claims. For example, although the tandem digital color copying machine is described as an example of the image forming apparatus in the aforementioned exemplary embodiment, it is natural that the invention is applicable to a monochrome or black-and-white copying machine or printer, an image forming apparatus of the inkjet method or the like. Furthermore, although the residual paper removing mode is automatically executed on the basis of the detection results obtained by the sensors in the aforementioned exemplary embodiment, it is natural that the residual paper removing mode may be executed in response to an instruction issued by an operator. Moreover, although the maintenance infeasible conveyance path RTj is present inside the fixing unit 15 exemplarily in the aforementioned exemplary embodiment, the residual paper removing mode of the invention is applicable to a form in which the maintenance infeasible conveyance path RTj is present in an arbitrary portion on the paper conveyance path RT. Furthermore, the maintenance infeasible conveyance path RTj may be a path that is more difficult to be maintained than the maintenance feasible conveyance path RTm but may be maintained to some extent.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image on recording paper;
a paper feeding unit that feeds the recording paper to the image forming unit;
an opening/closing door for maintenance, that is provided to be opened/closed by an operator;
a paper conveyance path through which the recording paper is conveyed from the paper feeding unit through the image forming unit to a paper outlet, the paper conveyance path including
a maintenance feasible conveyance path that allows an operator to maintain with the opening/closing door opened and
a maintenance infeasible conveyance path that does not allows the operator to maintain even if the opening/closing door is opened; and
a residual paper detecting unit that detects residual paper remaining on the maintenance infeasible conveyance path,
wherein new recording paper is fed to the paper conveyance path when the residual paper detecting unit has detected the residual paper after opening and closing the opening/closing door.

2. The image forming apparatus according to claim 1, further comprising:
a fixing unit that fixes the image on recording paper; and
a discharging unit that conveys the recording paper outside the image forming apparatus,
wherein the residual paper detecting unit detects as the residual paper, the recording paper remaining in a portion of the paper conveyance path disposed between the fixing unit and the discharging unit.

3. The image forming apparatus according to claim 2, further comprising:
a timing adjusting unit that conveys and feeds the recording paper to the image forming unit at precedently determined timing; and
a paper detecting unit that detects the recording paper present in a portion of the paper conveyance path disposed between the timing adjusting unit and the fixing unit,
wherein new recording paper is fed by the paper feeding unit when the paper detecting unit does not detect the recording paper and the residual paper detecting unit detects the recording paper.

4. The image forming apparatus according to claim 1,
wherein the new recording paper is repeatedly fed within a precedently determined number of times until the residual paper detecting unit detects no residual paper.

5. The image forming apparatus according to claim 2,
wherein the fixing unit fixes the image by using a heating source, and a heating temperature employed in feeding the new recording paper is set to be lower than a heating temperature employed in fixing the image on recording paper.

6. The image forming apparatus according to claim 1,
wherein the image forming unit includes transfer rollers disposed to oppose each other on the paper conveyance path,
the transfer rollers electrostatically transfers the image onto the recording paper, and
when the new recording paper is fed, the new recording paper is charged by the transfer roller.

7. The image forming apparatus according to claim 1,
wherein the fixing unit and the discharging unit are idled before feeding the new recording paper.
